(19) United States
(12) Patent Application Publication
(10) Pub. No.: US 2026/0097703 A1
(43) Pub. Date: Apr. 9, 2026

(54) WET SAND TRAILER

(71) Applicant: The Modern Group, Ltd., Beaumont, TX (US)

(72) Inventor: Gary MARKHAM, Beaumont, TX (US)

(21) Appl. No.: 19/346,124

(22) Filed: Sep. 30, 2025

Related U.S. Application Data
(60) Provisional application No. 63/703,756, filed on Oct. 4, 2024.

(51) Int. Cl. B60P 1/56

(52) U.S. Cl. CPC B60P 1/56

(57) ABSTRACT

A belly dump trailer includes a long axis and a deck extending along the long axis. The belly dump trailer also includes a bogie, the bogie attached to the deck and a hopper, the hopper extending through the deck, the hopper having a top opening and a bottom opening, the top opening larger than the bottom opening. The belly dump trailer further includes cross mount mounting connectors and longitudinal mount mounting connectors attached to the deck and a relocatable gate assembly adapted to mount on the cross mount mounting connectors and the longitudinal mount mounting connectors. The relocatable gate assembly is adapted to be mounted along the long axis or perpendicular to the long axis.

### CROSS-REFERENCE TO RELATED APPLICATIONS

This application is a nonprovisional application which claims priority from U.S. provisional application number 63/703,756, filed October 4, 2024, which is incorporated by reference herein in its entirety.

### TECHNICAL FIELD/FIELD OF THE DISCLOSURE

The present disclosure relates generally to a wet sand trailer.

### BACKGROUND OF THE DISCLOSURE

Fracing operations traditionally use proppant to prop open fractures created in the fracing operation. Frequently, the proppant used is wet sand. In some traditional embodiments, wet sand is transported to the fracing site in a fixed gate belly dump trailer. In a fixed gate belly dump trailer, the gate through which the load is dumped is fixed in place, either longitudinally along the long axis of the trailer or perpendicular to the long axis of the trailer.

### SUMMARY

The present disclosure provides for a belly dump trailer. The belly dump trailer includes a long axis and a deck extending along the long axis. The belly dump trailer also includes a bogie, the bogie attached to the deck and a hopper, the hopper extending through the deck the hopper having a top opening and a bottom opening, the top opening larger than the bottom opening. The belly dump trailer further includes cross mount mounting connectors and longitudinal mount mounting connectors attached to the deck and a relocatable gate assembly adapted to mount on the cross mount mounting connectors and the longitudinal mount mounting connectors. The relocatable gate assembly is adapted to be mounted along the long axis or perpendicular to the long axis.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1A depicts a side view of a belly dump trailer with the relocatable gate assembly positioned along the length of the belly dump trailer consistent with certain embodiments of the present disclosure.

FIG. 1B depicts a front view of a belly dump trailer with the relocatable gate assembly positioned along the length of the belly dump trailer consistent with certain embodiments of the present disclosure.

FIG. 1C depicts a rear view of a belly dump trailer with the relocatable gate assembly positioned along the length of the belly dump trailer consistent with certain embodiments of the present disclosure.

FIG. 2A depicts a side view of a belly dump trailer with the relocatable gate assembly positioned across the length of the belly dump trailer consistent with certain embodiments of the present disclosure.

FIG. 2B depicts a front view of a belly dump trailer with the relocatable gate assembly positioned across the length of the belly dump trailer consistent with certain embodiments of the present disclosure.

FIG. 2C depicts a rear view of a belly dump trailer with the relocatable gate assembly positioned across the length of the belly dump trailer consistent with certain embodiments of the present disclosure.

FIG. 3A is an end view of a belly dump trailer without the relocatable gate assembly consistent with certain embodiments of the present disclosure.

FIG. 3B is a side view of a belly dump trailer without the relocatable gate assembly consistent with certain embodiments of the present disclosure.

FIGS. 4A and 4B are views of the pinning mechanism of the relocatable gate assembly consistent with certain embodiments of the present disclosure.

FIGS. 5A and 5B are side views of mounting connectors consistent with certain embodiments of the present disclosure.

FIG. 6 is a side view of the jaws of the relocatable gate assembly consistent with certain embodiments of the present disclosure.

FIGS. 7A and 7B are isometric views of the jaws of the relocatable gate assembly consistent with certain embodiments of the present disclosure.

FIG. 8 is an isometric view of an equalizer housing assembly and equalizer assembly consistent with certain embodiments of the present disclosure.

FIG. 9 is a side view of an equalizer assembly consistent with certain embodiments of the present disclosure.

FIG. 10 is a side view of a relocatable gate assembly consistent with certain embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

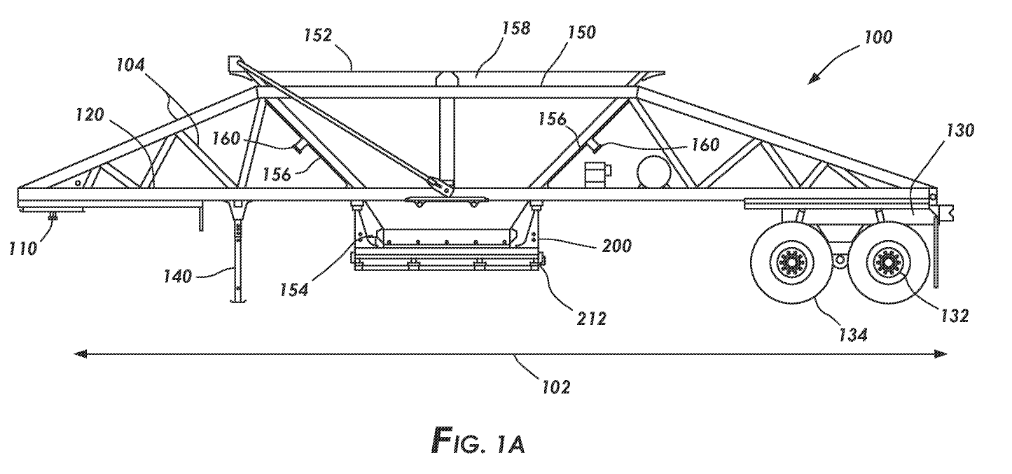

FIG. 1A depicts a side view of belly dump trailer 100 with relocatable gate assembly 200 positioned along long axis 102 of belly dump trailer 100. As is described further hereinbelow, relocatable gate assembly 200 is a gate assembly that may be repositioned along and astride belly dump trailer 100.

Belly dump trailer 100 may include hitch 110 attached to deck 120. Deck 120 may extend the length of belly dump trailer 100 along long axis 102. Also attached to deck 120 is bogie 130. As one of ordinary skill in the art with the benefit of this disclosure will appreciate, a bogie is an undercarriage pivoted beneath deck 120. Bogie 130 may include wheels 132 and tires 134. Belly dump trailer 100 may also include retractable leg 140 that may be extended to stabilize belly dump trailer 100. Belly dump trailer 100 may also include hopper 150 extending through deck 120 and wherein the load may be positioned. Support struts 104 may be affixed to deck 120 and used to support the weight of hopper 150. Hopper 150 may include a larger top opening 152 than bottom opening 154. Hopper 150 may be filled through top opening 152 and dumped through bottom opening 154. In certain embodiments, one or more vibrators 160 may be affixed to outside 156 of hopper 150. Vibrators 160 may be adapted to break up sand clumps on the inside of hopper 150 to facilitate sand dumping through bottom opening 154. Vibrators 160 may be air or electrically powered and may be powered by truck air or by the alternator of the truck. Vibrators 160 may have a rotating eccentric cam that impacts the trailer as the lobe of the cam passes a trailer wall plate. This impact provides the “thump” of vibrators 160. The frequency of the “thump” is based on the rotation of the rotating eccentric cam.

FIGS. 1B and 1C depict a front view and rear view, respectively, of belly dump trailer 100 with relocatable gate assembly 200 positioned along long axis 102 of belly dump trailer 100. FIGS. 1B and 1C depict jaws 210 of relocatable gate assembly 200. Jaws 210 may open partially or fully to allow sand to dump from hopper 150 to dump through bottom opening 154. FIGS. 1B and 1C also depict a portion of equalizer assembly 250, a part of relocatable gate assembly, further described herein below.

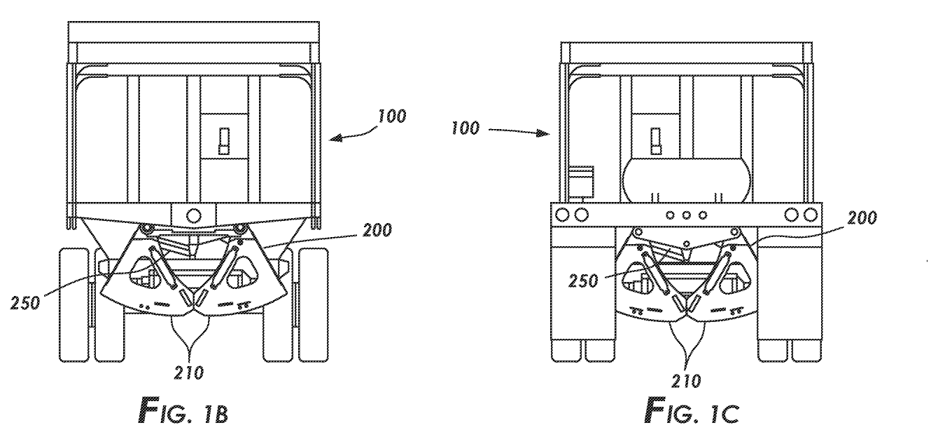

FIG. 2A depicts a side view of belly dump trailer 100 with relocatable gate assembly 200 positioned across or perpendicular to long axis 102 of belly dump trailer 100. FIGS. 2B and 2C depict a front view and rear view, respectively, of belly dump trailer 100 with relocatable gate assembly 200 positioned across or perpendicular to long axis 102 of belly dump trailer 100. FIG. 2A further depicts jaws of relocatable gate assembly 200. Jaws 210 may open partially or fully to allow sand to dump from hopper 150 to dump through bottom opening 154.

FIG. 2A depicts operation connectors 212 as part of jaws 210 of relocatable gate assembly 200. Operation connectors 212 allow assemblies to attach to open and close jaws 210, for example, from the cab of a truck attached to belly dump trailer 100or at location along deck 120. Operation connectors 212 are described further below.

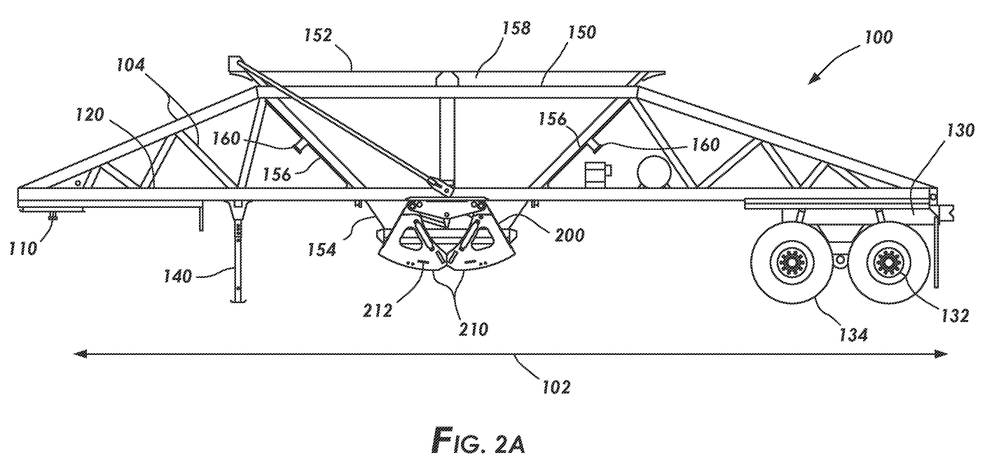

FIGS. 3A and 3B depict an end view and side view, respectively, of belly dump trailer 100 without relocatable gate assembly 200 installed so as to show mounting connectors for relocatable gate assembly 200 positioned on deck 120. Cross mount mounting connectors 124 and longitudinal mount mounting connectors 126 are mounting connectors for cross or perpendicular mounting of relocatable gate assembly 200 and longitudinally mounting of relocatable gate assembly 200, respectively. FIGS. 3A and 3B further depict movable plates 170. Movable plates 170 may be bolted to or otherwise removably affixed to hopper 150. In certain embodiments, movable plate contour 172 may match gate contour 138 of jaws 210. Movable plates 170 may be mounted on each side of hopper 150 when relocatable gate assembly 200 is mounted transverse and on the back and front of hopper 150 when relocatable gate assembly 200 is mounted longitudinal.

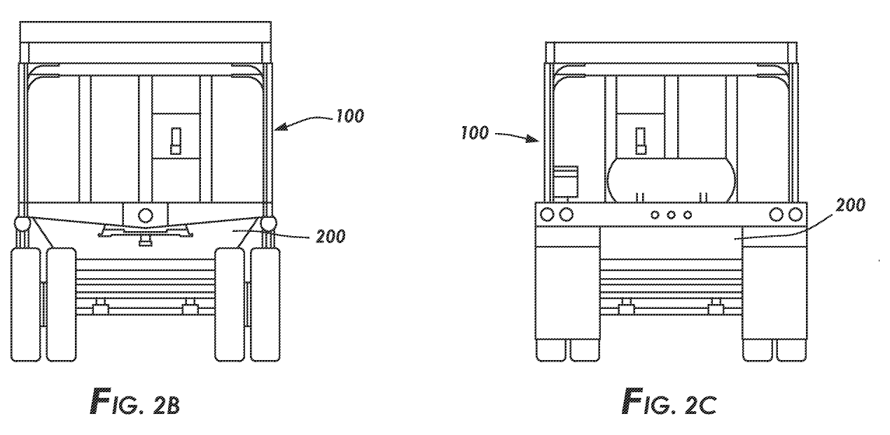

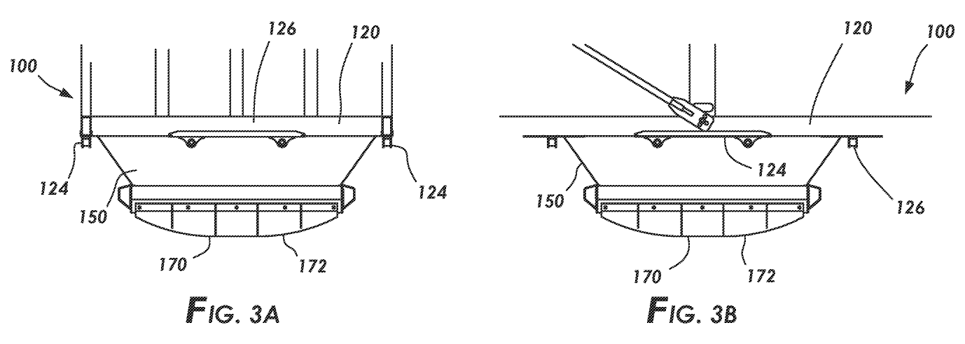

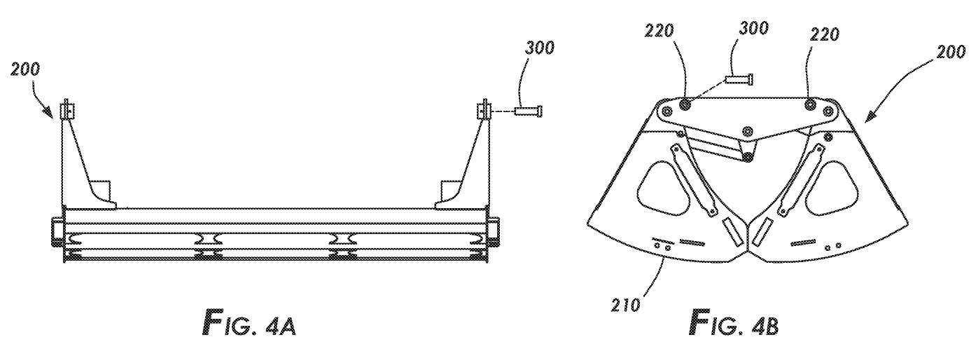

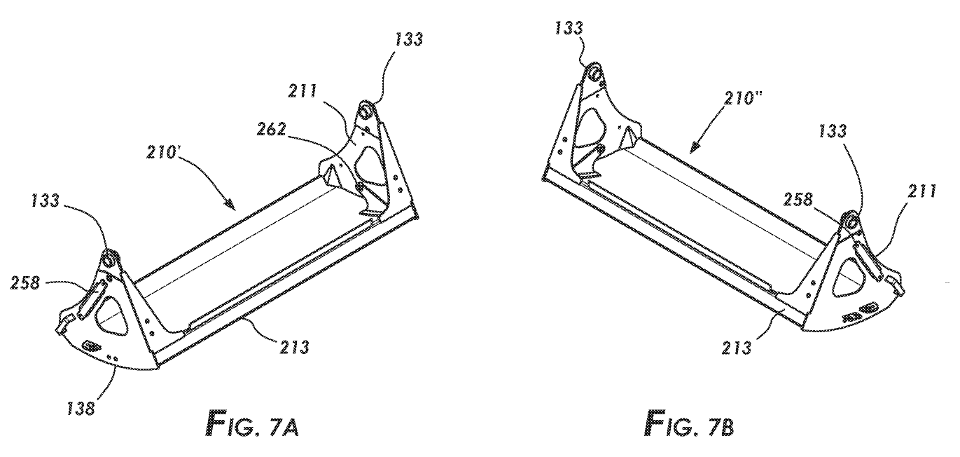

FIGS. 5A, 5B, and 6 further depict longitudinal mount mounting connectors 126 and cross mount mounting connectors 124, respectively. Longitudinal mount mounting connectors 126 and cross mount mounting connectors 124 are affixed to deck 120, such as by welding. Longitudinal mount mounting connectors 126 and cross mount mounting connectors 124 may include body 125 and mounting holes 127. As shown in FIG. 4, relocatable gate assembly 200 may be affixed to longitudinal mount mounting connectors 126 and cross mount mounting connectors 124 by inserting removable pin 300 through gate mounting hole 220 of equalizer housing assembly 240, described below and shown in FIG. 8. By removing removable pin 300, relocatable gate assembly 200 may be reoriented from a mount along the longitudinal axis to a cross axis or perpendicular mount.

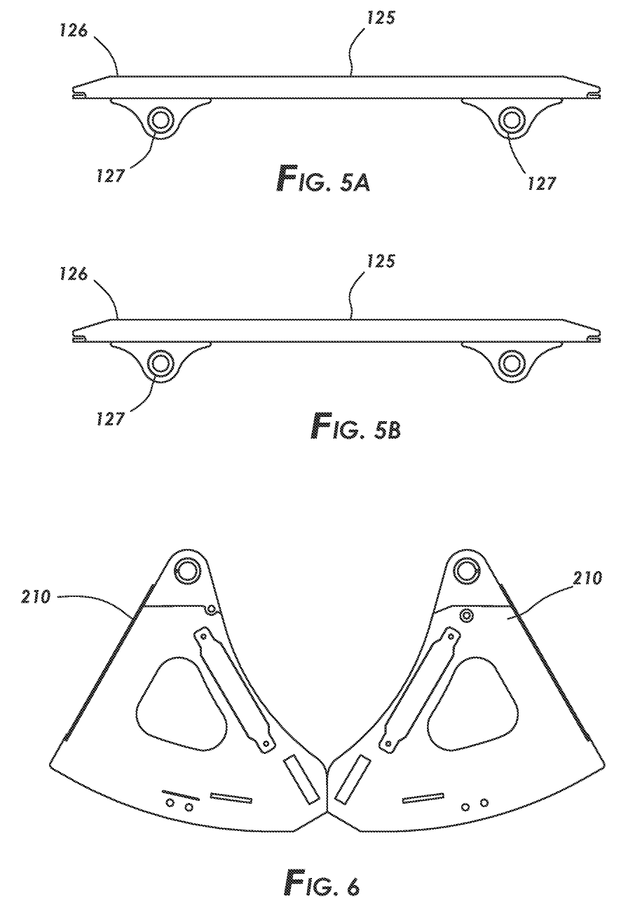

Relocatable gate assembly 200 may include jaws 210, as shown in detail in FIGS. 4, 6, and 7. Relocatable gate assembly 200 may include two jaws 210. When relocatable gate assembly 200 is positioned perpendicular to long axis 102, as shown in FIG. 7, passenger side jaw 210’ and driver side jaw 210’’ may be mirror images. As one of skill in the art with the benefit of this disclosure will appreciate, when relocatable gate assembly 200 is positioned along long axis 102, passenger side jaw 210’ and driver side jaw 210’’ may become front jaw 210’ and rear jaw 210’’, for example.

Jaws 210 may each include an upper jaw portion 211 and a lower jaw portion 213 affixed to or formed integrally with one another. Lower jaw portions 213 may control the amount of material within hopper 150 allow to pass through relocatable gate assembly 200. Upper jaw portions 211 may be pivotably connected to equalizer housing assembly 240 through jaw mounting holes 133. As jaws 210 pivot about jaw mounting holes 133, corresponding jaws (such as passenger side jaw 210’ and driver side jaw 210’’) may move closer together or further apart to control the amount of material within hopper 150 to pass through bottom opening 154.

FIG. 8 depicts equalizer housing assembly 240. Equalizer housing assembly 240 may affix relocatable gate assembly 200 to deck 120 so that relocatable gate assembly 200 may communicate with bottom opening 154. As described above, equalizer housing assembly 240 may include gate mounting holes 220 and jaw mounting holes 133. By removing removable pin 300 from gate mounting holes 220, relocatable gate assembly 200 may be reoriented from a mount along the longitudinal axis to a cross axis or perpendicular mount, or removed entirely from deck 120.

In certain embodiments, such as that show in FIG. 8, equalizer housing assembly 240 may include two parallel plates 242, allowing for slot 244 positioned therebetween. Equalizer assembly 250 may be positioned between two parallel plates 242 and held in place by two parallel plates 242. As further shown in FIG. 8, each parallel plate 242 may include gate mounting holes 220 and jaw mounting holes 133.

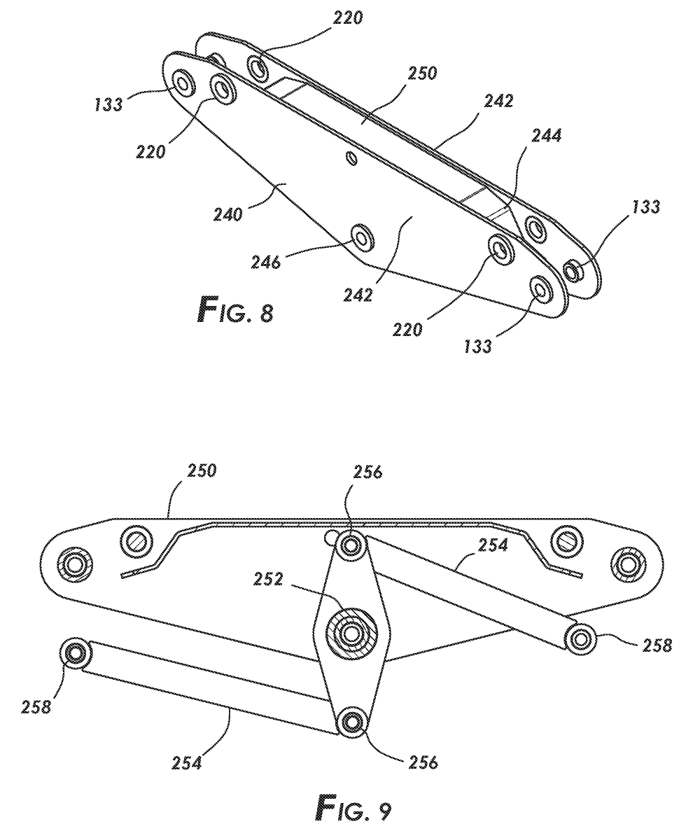

Equalizer assembly 250, as shown in FIG. 9 may be used to equalize opening of jaws 210, i.e., open the jaws at about the same rate or to the same extent. Equalizer assembly 250 may include pivot cam 252. Pivot cam 252 may be pivotally connected to equalizer assembly housing 240 at equalizer pivot attachment point 246. Equalizer arms 254 may be pivotally connected to pivot cam 252 at bracket pivot points 256. In addition, jaws 210 may be affixed to equalizer arms 254 at jaw attachment points 258.

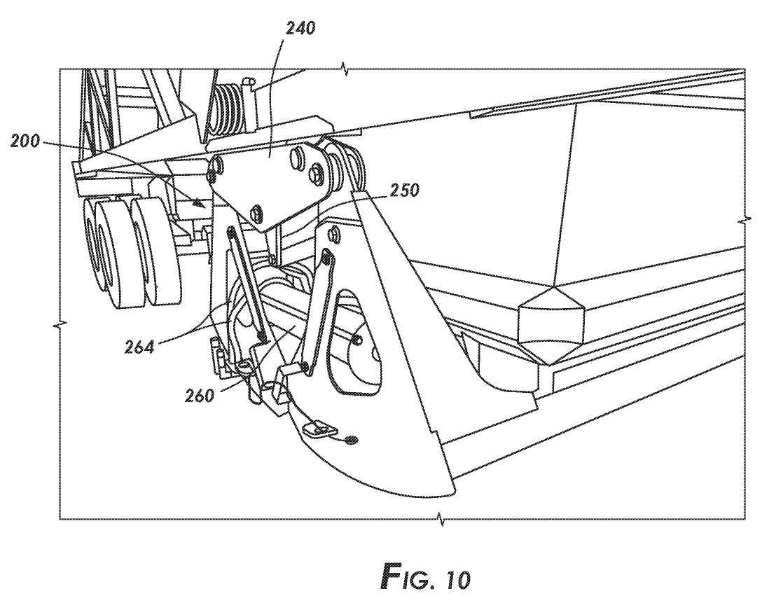

Relocatable gate assembly 200 may also include one or more hydraulic cylinders 260, as shown in FIG. 10. Hydraulic cylinders 260 may be mounted to jaws 210 at mounting links 262, as shown in FIG. 7 and connected to operation connectors 212 through hoses 264. Operation connectors 212 may connect to an air or hydraulic fluid source. By operating hydraulic cylinders 260, jaws 210 may be opened or closed.

FIGS. 1A and 2A depict bang boards 158. In certain embodiments, bang boards 158 may be wood boards that are replaceable to protect belly dump trailer 100 from equipment such as a front-end loader on each side. In certain embodiments, bang boards 158 may be the top 6” of hopper 150. In some embodiments, hopper extensions may bring the front and rear of hopper 150 up to the level of bang boards 158.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A belly dump trailer comprising:
a long axis;
a deck, the deck extending along the long axis;
a bogie, the bogie attached to the deck;
a hopper, the hopper extending through the deck, the hopper having a top opening and a bottom opening, the top opening larger than the bottom opening;
cross mount mounting connectors and longitudinal mount mounting connectors attached to the deck; and
a relocatable gate assembly mounted on the cross mount mounting connectors or the longitudinal mount mounting connectors, the relocatable gate assembly adapted to be mounted along the long axis or perpendicular to the long axis.

2. The belly dump trailer of claim 1, wherein the relocatable gate assembly includes jaws.

3. The belly dump trailer of claim 2, wherein the jaws are adapted to open partially and fully.

4. The belly dump trailer of claim 2 further comprising operation connections on the relocatable gate assembly adapted to open and close the jaws.

5. The belly dump trailer of claim 1 further comprising an air operated vibrator attached to an outside of the hopper.

6. The belly dump trailer of claim 1, wherein the relocatable gate assembly is pinned to the cross mount mounting connectors and longitudinal mount mounting connectors.

7. The belly dump trailer of claim 6, wherein the pinning is accomplished by a removable pin.

8. The belly dump trailer of claim 1, wherein the relocatable gate assembly comprises:
two jaws, each jaw the mirror image of the other jaw;
an equalizer housing assembly, the jaws pivotably connected to the equalizer housing assembly, the equalizer housing assembly wherein the relocatable gate assembly is mounted on the cross mount mounting connectors through the equalizer housing assembly; and
an equalizer, the equalizer connected to the equalizer housing assembly and pivotably connected to the jaws.

9. The belly dump trailer of claim 8, wherein each jaw includes an upper jaw portion and a lower jaw portion, wherein the upper jaw portion is pivotably connected to the equalizer housing assembly through jaw mounting holes.

10. The belly dump trailer of claim 8, wherein the equalizer housing assembly includes two parallel plates with a slot between the plates.

11. The belly dump trailer of claim 10, wherein the equalizer assembly is positioned between the two parallel plates.

12. The belly dump trailer of claim 11, wherein the equalizer assembly includes a pivot cam, the pivot cam pivotally connected the equalizer housing assembly.

13. The belly dump trailer of claim 12, wherein the equalizer assembly includes equalizer arms, the equalizer arms pivotally connected to the pivot cam and wherein each arm is affixed to a jaw.

14. The belly dump trailer of claim 13, wherein the equalizer assembly is adapted to open the jaws at the same rate or the same extent.

15. The belly dump trailer of claim 8 further comprising a hydraulic cylinder, the hydraulic cylinder mounted to the jaws at a mounting link, the hydraulic cylinder adapted to open and close the jaws.

16. The belly dump trailer of claim 15 further comprising operation connectors, the operation connectors connected to the hydraulic cylinder by hoses.

17. The belly dump trailer of claim 1 further comprising a plurality of movable plates, the movable plates removably affixed to hopper 150.

18. The belly dump trailer of claim 17, wherein the jaws have a gate contour, the movable plates have a movable plate contour, and wherein the gate contour and the movable plate contour match.
